(19) United States
(12) Patent Application Publication
(10) Pub. No.: US 2002/0073198 A1
(43) Pub. Date: Jun. 13, 2002

(54) Notification system, notification server, notification method, and recording medium recording notification program

(75) Inventor: Kazuhiro Sakata, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/988,591

(22) Filed: Nov. 20, 2001

(30) Foreign Application Priority Data
Nov. 24, 2000 (JP) 357758/2000

(51) Int. Cl. G06F 15/16

(52) U.S. Cl. 709/224; 709/206

(57) ABSTRACT

In a notification system for notifying a user of a processing item at a specific timing in accordance with an information input about the processing item including an execution position and expiration date of execution, whether to notify the user of the processing item is determined on the basis of a distance between a current position of the user and the execution position included in the processing item, and a time difference between the current time and the expiration date of execution included in the processing item. A notification server, notification method, and recording medium are also disclosed.

### BACKGROUND OF THE INVENTION

1. Field of the Invention

This invention relates to a notification system, a notification server, a notification method, and a recording medium recording a notification program and, more particularly, to a notification system, a notification server, a notification method, and a recording medium recording a notification program, which are characterized by notifying a user of the execution timing of a processing item registered by the user,

2. Description of the Prior Art

A conventional notification system, a notification server, a notification method, and a recording medium recording a notification program are used for action management and schedule management for users.

FIG. 1 shows an example of the arrangement of a conventional notification system.

Referring to FIG. 1, a notification apparatus 500 is comprised of a processing item input section 510 having the function of allowing a user to input information about a processing item, a processing item storage section 520 having the function of storing the information of the processing item, a notification determination section 530 having the function of determining whether to notify the user of information, a timepiece section 540 having the function of measuring the current time, and a notification section 550 having the function of notifying the user of information by sound, light, or the like.

FIG. 2 shows an example of data stored in the processing item storage section 520.

In this case, the entries of each processing item are “processing item name”, “remarks”, “expiration date”, “degree of importance”, and “execution flag” indicating the presence/absence of processing. The degree of importance is a value indicating the importance of a processing item for the user. In this case, the degree of importance is represented by a natural number equal to or less than 10. In some conventional systems, a value representing the specific time of notification before the expiration date of each processing item is registered instead of a degree of importance. In this case, for example, a value representing “10 min”, “2 hr”, “3 days”, or the like is stored.

A procedure taken by a conventional system will be described below.

The processing performed by the system is constituted by two stages, i.e., (1) inputting a processing item, and (2) notifying information.

(1) Inputting Information about Processing Item:

The user inputs information about a processing item through the processing item input section 510. When processing is executed, the user changes the execution flag of the processing item from “unexecuted” to “executed” through the processing item input section 510.

(2) Notification:

This notification processing is executed by the notification determination section 530. The processing executed by the notification determination section 530 will be described with reference to FIG. 3.

First of all, the notification determination section 530 acquires the current time from the timepiece section 540 (step S51). The processing in steps S52 to S54 is then repeated with respect to each processing item stored in the processing item storage section 520.

First of all, the notification determination section 530 calculates the notification time of the processing item (step S52). As a method of calculating this time, for example, a method of “setting notification time by subtracting a period of time (min) corresponding to the value obtained by multiplying a degree of importance by 10 from an expiration date of processing” is available. According to this method, for example, the notification time of the entry “electronic bank transfer of rent” of a processing item shown in FIG. 2 becomes “Oct. 31, 2000, 24:40:00” 80 min before the expiration date “Oct. 31, 2000, 24:00:00”.

If a specific period of time before a processing time is registered as the timing of notification instead of a degree of importance in the processing item storage section 520, notification time is obtained by subtracting the registered time from the expiration date of execution.

The notification determination section 530 then checks whether the notification time has elapsed (step S53). If the notification time has elapsed, the notification determination section 530 causes the notification section 550 to notify the user of the corresponding information (step S54). The notification section 550 notifies the user by sound, light, or the like, and presents information such as the name of the processing item and the expiration date on the display screen of an output unit. If it is determined in step S53 that the notification time has not elapsed, the processing about the processing item is terminated, and the flow returns to step S51.

After the processing in steps S52 to S54 is executed for all processing items, the processing in step S51 is repeated. Note that when the processing in step S51 and the subsequent steps is repeated, the flow may wait for a predetermined period of time.

With the above processing, the user can receive an execution notification about the processing item registered by himself/herself at a proper timing.

An example of conventional systems is a system for managing a schedule to be executed at specific times and notifying a user of execution of a given item a predetermined period of time before the execution time, as disclosed in Japanese Unexamined Patent Publication No. 11-94583. This system manages a schedule as processing items to be executed at predetermined times instead of processing items to be executed before predetermined expiration date, and performs notification in advance on the basis of the current time and the position of the user to allow the user to execute the schedule at the predetermined times.

In the conventional system, the timing of notification of the execution of a processing item for the user is determined by using only information about the expiration date of the execution of the processing item. In consideration of convenience for the user, however, this determination on notification may be performed more properly by using position information such as the position of the user and the position where a processing item is to be executed as well as time information such as an expiration date. Consider, for example, a processing item defining that the user must go to the bank before a predetermined expiration date. Assume that the user has a sufficiently long period of time before the expiration date of execution. Even in this case, if the user is notified of the execution when he/she is near the bank, he/she can execute the processing item at a proper timing.

In addition, the conventional system cannot use position information in notifying the user of the execution of a processing item. The system disclosed in Japanese Unexamined Patent Publication No. 11-94583 performs notification by using time information and position information. However, this system manages a schedule to be executed at specific times as notification targets but cannot manage and notify processing items to be executed before specific expiration dates of execution.

### SUMMARY OF THE INVENTION

The present invention has been made in view of the foregoing circumstances in the prior art, and has for its object to provide a notification system which manages processing items to be executed by a user in the future, and can notify the user of information about each processing item at a proper timing in accordance with the time and the position of the user.

In order to achieve the above object, according to the first aspect of the present invention, there is provided a notification system for receiving a processing item input including an execution position and expiration date of execution and notifying a user of information about the processing item at a specific timing, wherein whether to execute notification is determined by using the distance between the current position of the user and the execution position of the processing item and the time difference between the current time and the expiration date of execution of the processing item.

According to the second aspect of the present invention, there is a notification server for notifying a user of a processing item including a stored expiration date of execution and a stored execution position at a specific timing, comprising processing item storage means having a function of storing a processing item, and notification determination means having a function of determining whether to notify the user of the processing item, on the basis of a time difference between current time and the expiration date included in the processing item stored in the processing item storage means and a distance between a current position and the execution position included in the processing item.

According to the third embodiment of the present invention, there is provided a notification method of notifying a user of a processing item including an expiration date and an execution position at a specific timing, comprising processing of acquiring information about current time and a current position of the user, processing of calculating a distance between the execution position included in the processing item and the current position of the user, processing of calculating a time difference the current time and an expiration date of execution included in the processing item, processing of calculating a degree of necessity of notification by using the distance and the time difference, and processing of determining whether to notify the user of the processing item, in accordance with a value of the degree of necessity of notification.

According to the fourth aspect of the present invention, there is provided a recording medium recording a program for executing a notification method of notifying a user of a processing item including an expiration date of execution and an execution position, the program comprising processing of acquiring each information about current time and a current position of the user, processing of calculating a distance between the execution position in the processing item and the current position of the user, processing of calculating a time difference between the current time and the expiration date of execution in the processing item, processing of calculating a degree of necessity of notification by using the distance and the time difference, and processing of determining on the basis of the value of the degree of necessity of notification whether to notify the user of the information of the processing item.

As is obvious from the above aspects, the notification system of the present invention can manage processing items to be executed by the user in the future, and can notify the user of information about a processing item at a proper timing on the basis of the time and the position of the user.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the arrangement of a conventional system;

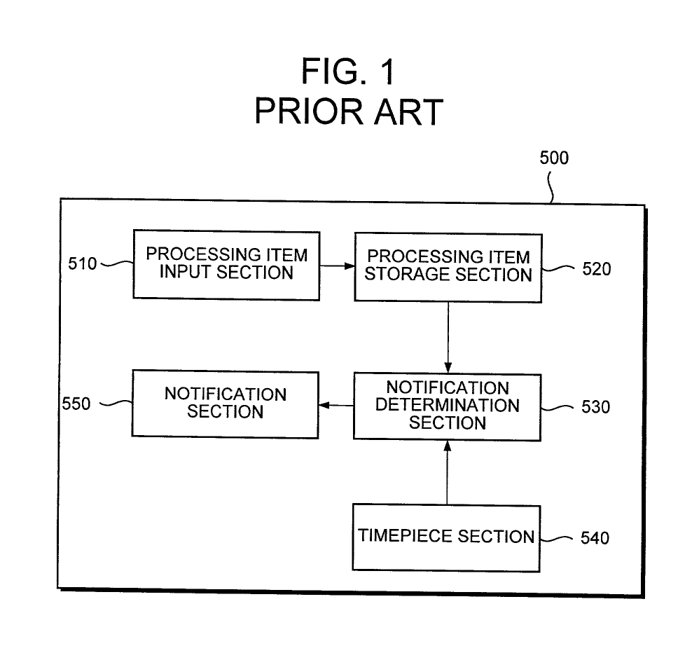

FIG. 2 is a view showing an example of the data stored in a processing item storage section in the conventional system;

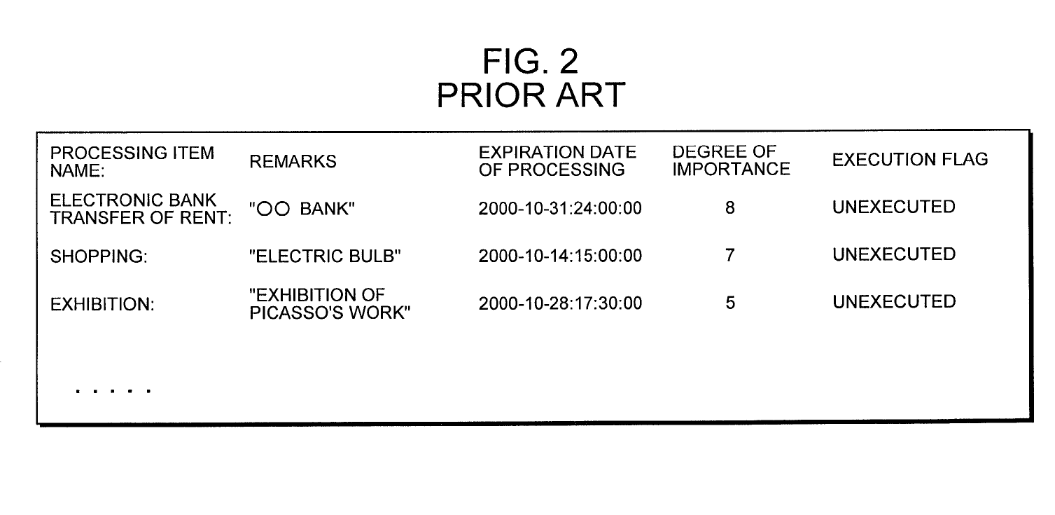

FIG. 3 is a flow chart showing the flow of notification processing in the conventional system;

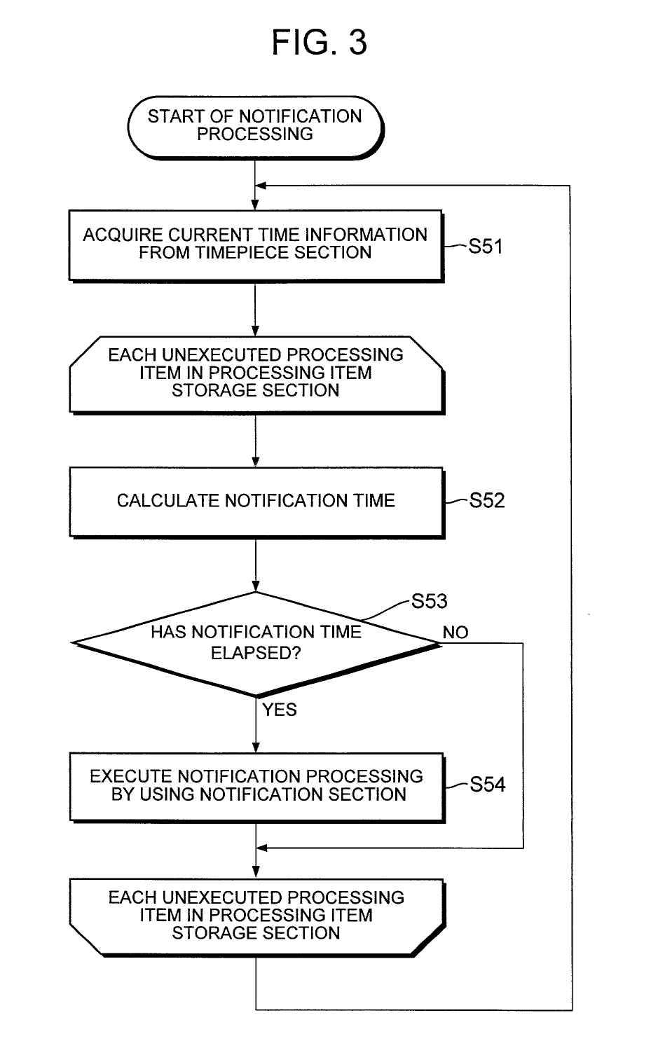

FIG. 4 is a block diagram showing the arrangement of the first embodiment of the present invention;

FIG. 5 is a view showing an example of the data stored in a processing item storage section in the first embodiment of the present invention;

FIG. 6 is a flow chart showing the flow of notification processing in the first embodiment of the present invention; and

FIG. 7 is a block diagram showing the arrangement of the second embodiment of the present invention.

### DETAILED DESCRIPTION OF THE PREFERRED EMBODIMENTS

A few preferable embodiments of the present invention will be described below with reference to the accompanying drawings.

First Embodiment

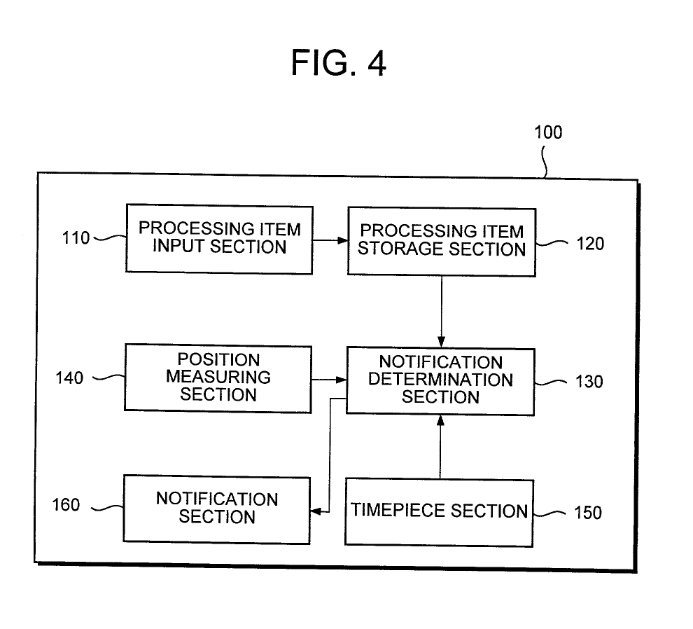

The first embodiment of the present invention will be described in detail below with reference to FIG. 4.

Referring to FIG. 4, a notification apparatus 100 according to the first embodiment of the present invention is comprised of a processing item input section 110 having the function of receiving information about a processing item input from a user, a processing item storage section 120 having the function of storing the processing item input to the processing item input section 110, a notification determination section 130 having the function of determining whether to notify the user of information about the processing item, a position measuring section 140 having the function of measuring the current position of the user, a timepiece section 150 having the function of measuring the current time, and a notification section 160 having the function of notifying the user of information about the processing item. This notification apparatus 100 is carried by the user.

The processing item input section 110 provides the user with an input unit such as a keyboard or mouse to allow the user to input a processing item. Note that an output unit such as an LCD may be provided, together with the input unit, to allow the user to easily input information about a processing item.

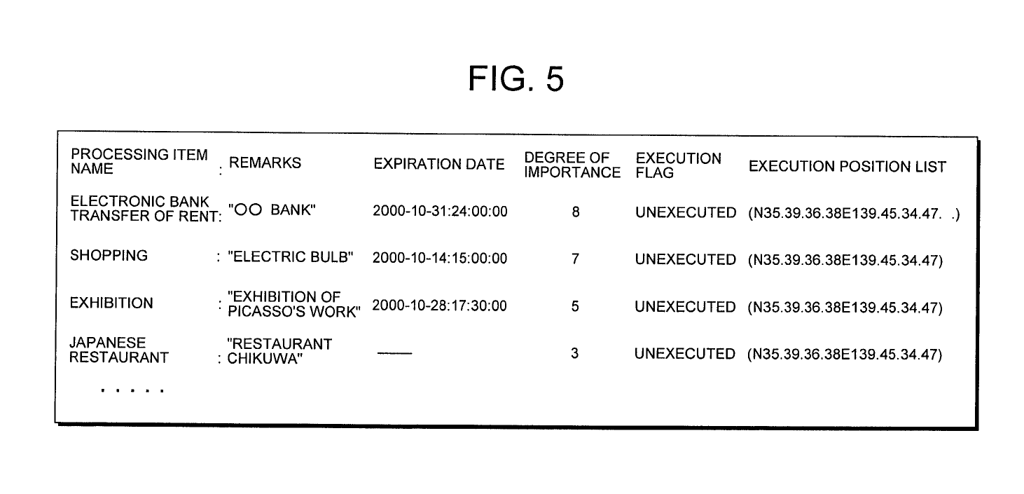

FIG. 5 shows examples of processing items stored in the processing item storage section 120. In this case, the entries of each processing item are “processing item name”, “remarks”, “expiration date”, “degree of importance”, “execution flag”, and “execution position list”.

Each entry will be described below.

“Processing item name” and “remarks” are entries for a processing item name and supplementary information and are used to let the user understand the contents of a processing item. These data are input by the user.

“Expiration date” is information indicating an expiration date for the execution of a processing item, which is input by the user. Note that the entry “expiration date” may be blank. In this case, no specific expiration date is set for the corresponding processing item, and hence the item is handled as one to be executed sometime in the future.

“Degree of importance” is a numerical value representing a degree of importance, which is input by the user. In this case, this information is indicated by a natural number from 1 to 10. An arbitrary range of this information may be set depending on the system. Note that the user need not always directly input a numerical value as a degree of importance. For example, the processing item input section 110 may provide choices like “very important”, “important”, and “unimportant”, assign a corresponding value as a degree of importance in accordance with the selection made by the user, and store it in the processing item storage section 120.

Alternatively, a default degree of importance may be set by the processing item input section 110. In this case, if the user designates no degree of importance, the default degree of importance may be used. A fixed degree of importance may be used for all processing items in a given system instead of setting a degree of importance for each processing item.

“Execution flag” represents whether the corresponding processing item has been executed or not, and takes either of values corresponding to “unexecuted” and “executed”. When the user newly registers a processing item with the processing item input section 110, “unexecuted” is set. When the user executes the processing item afterward, “unexecuted” is changed to “executed” through the processing item input section 110.

“Execution position list” is information about a place where the corresponding processing item is to be executed, which is designated by the user. In this embodiment, an execution position is represented by a latitude and longitude. If a processing item should be executed in one place, one position information is stored. If a processing item should be executed in a plurality of places, a list of all pieces of position information is stored. If, for example, a processing item is shopping in a specific store, the position information of the store is stored. If an processing item is shopping in one of a plurality of stores, a list of pieces of position information of all the stores is stored. Note that a position information database may be managed in the processing item input section 110 or processing item storage section 120. In this case, information such as a store name, other than position information, is input as an execution position from the user to search the position information database for the corresponding position information, and the found position information is used as an execution position.

Alternatively, the processing item input section 110 or processing item storage section 120 may automatically determine an execution position in accordance with the processing item name and the contents of remarks input by the user, and the corresponding position information list may be stored as an execution position in the processing item storage section 120.

With these processes, even if the user does not know an accurate execution position and it is difficult for the user to directly input position information, he/she can input an execution position list. In the case of a processing item independent of a place, like “take medicine”, “execution position list” becomes blank.

The position measuring section 140 measures the current position of the user by using a GSP or the like.

The notification section 160 has the function of notifying the user of information by light, sound, vibration, or the like. The notification section 160 may also have the function of providing the user with detailed information about a processing item by using an LCD or the like.

The notification determination section 130 determines whether to notify the user of a processing item, on the basis of the information of the processing item stored in the processing item storage section 120, the information of the current position measured by the position measuring section 140, and the information of the current time measured by the timepiece section 150. If notification is required, the notification determination section 130 notifies the user of the information by using the notification section 160. In addition, the notification determination section 130 holds a “notification threshold” which is a fixed value for determination.

Notification processing in the first embodiment of the present invention will be described in detail next.

This processing is comprised of two stages, i.e., (1) inputting information about a processing item, and (2) notifying information. Each stage will be described below.

(1) Inputting Information about Processing Item

When the user inputs information about a processing item, the processing item input section 110 stores it in the processing item storage section 120. In addition, upon reception of a request to change the execution flag of the corresponding processing item from “unexecuted” to “executed” from the user, the processing item input section 110 changes the execution flag of the processing item in the processing item storage section 120. With this operation, the user who has executed the processing item can stop notification about the processing item afterward.

(2) Notification

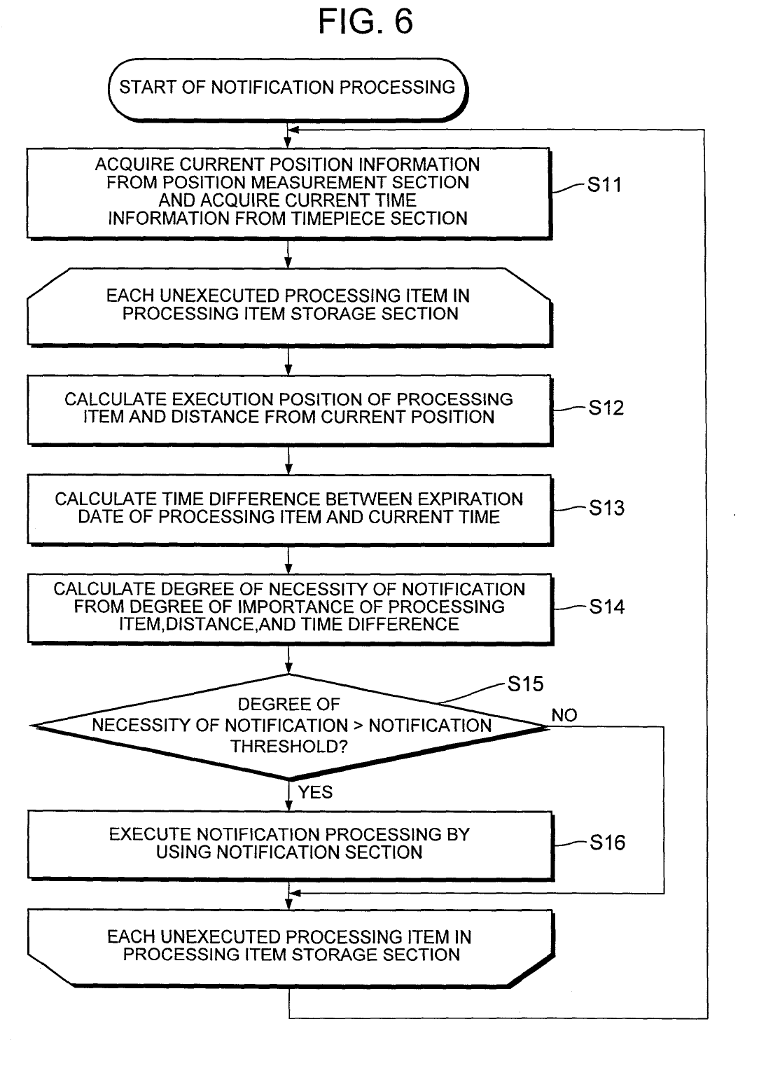

This notification processing is executed by the notification determination section 130. FIG. 6 shows the flow of processing performed by the notification determination section 130.

First of all, the notification determination section 130 acquires the information of the current position of the user from the position measuring section 140 and the information of the current time from the timepiece section 150 (step S11).

The notification determination section 130 then executes the processing from step S12 to step S16 with respect to each processing item, of the processing items in the processing item storage section 120, for which execution flags are set to “unexecuted”.

First of all, the notification determination section 130 calculates the distance between the current position and the execution position contained in the processing item (step S12). If pieces of position information exist in the execution position list contained in the processing item, the notification determination section 130 calculates a distance for each position, and uses the shortest distance. If the entry “execution position list” is blank, an infinite distance is set.

The notification determination section 130 then calculates the time difference between the current time and the expiration date contained in the processing item (step S13). For a processing item having no expiration date, an infinite time difference is set.

The notification determination section 130 calculates a degree of necessity of notification from the distance obtained in step S12, the time difference obtained in step S13, and the degree of importance of the processing item (step S14). The degree of necessity of notification is a value indicating the necessity of notification to the user. The larger this value is, the higher the necessity is.

For example, letting x be the distance (km), y be the time difference, and z be the degree of importance of the processing item, the value given by (1/x+1/y+z) is set as a degree of necessity of notification. Note that a calculation method is not limited to this method. An arbitrary method may be used in the system as long as a degree of necessity of notification can be uniquely determined by a distance and time difference.

The notification determination section 130 checks whether the degree of necessity of notification of the processing item calculated in step S14 exceeds a set notification threshold (step S15). If it is determined in step S15 that the degree of necessity of notification exceeds the notification threshold, the notification determination section 130 notifies the user of the processing item (step S16). More specifically, the notification section 160 notifies the user of the information by light, sound, vibration, or the like, and presents the information contained in the processing item, e.g., a name, remarks, expiration date, and execution position. Thereafter, the notification determination section 130 repeats the processing associated with the next unexecuted processing item from step S12.

If it is determined in step S15 that the degree of necessity of notification is equal to or less than the notification threshold, the notification determination section 130 repeats the notification processing associated with the next unexecuted processing item from step S12. When the notification determination section 130 completes the processing from step S12 to step S16 for all the unexecuted processing items, the flow returns to step S11 to repeat the processing. Note that a standby state may be set for a predetermined period of time before the flow returns to step S11.

With the above processing, the notification apparatus 100 can notify the user of information about a registered processing item at a proper timing in accordance with the current time and the current position of the user.

Second Embodiment

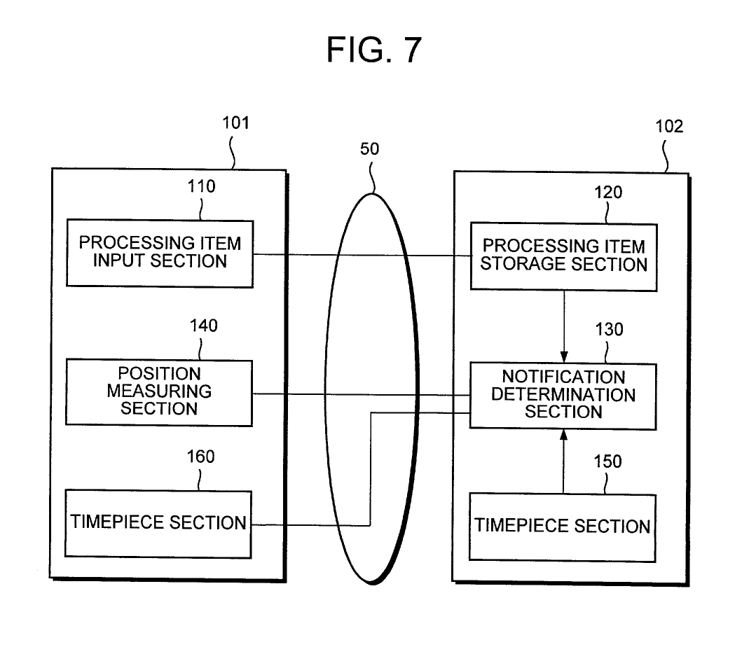

FIG. 7 shows the arrangement of the second embodiment of the present invention.

The second embodiment is comprised of a notification client 101, a notification server 102, and a network 50 for connecting them to each other. The notification client 101 is comprised of a processing item input section 110, position measuring section 140, and notification section 160. The notification server 102 is comprised of a processing item storage section 120, notification determination section 130, and timepiece section 150. The transfer roller 10 is carried by the user.

The network 50 is formed by a radio public network, Internet, or the like, and allows exchange of information between the notification client 101 and the notification server 102. The functions of the processing item input section 110, position measuring section 140, notification section 160, processing item storage section 120, notification determination section 130, and timepiece section 150 are the same as those in the first embodiment.

The processing in this system is also the same as that in the first embodiment, and hence a description thereof will be omitted.

In the second embodiment, the system is divided into the notification client 101 and the notification server 102 to reduce the amount of processing performed by the terminal carried by the user, allowing reductions in the weight and size of the terminal. In addition, by connecting one notification server 102 to a plurality of notification clients 101, notification processing for a plurality of users can be managed by the single server.

The notification client 101 is further divided into a portion formed by the processing item input section 110 and a portion constituted by the position measuring section 140 and notification section 160. In this case, the user may carry only the latter portion. This makes it possible to further facilitate inputting of information about processing items by implementing the former portion on a device that is difficult to carry but has excellent an input/output function, such as a PC connected to the Internet.

Modification:

The entries of each processing item input by the user with the processing item input section 110 and stored in the processing item storage section 120 are not limited those used in each embodiment described above. Additional information entries may be prepared. In each embodiment described above, in the processing in step S15, whether to perform notification is performed is determined on the basis of only the relationship in magnitude between the degree of necessity of notification and the notification threshold. Additional information may be used for this determination. When additional information is to be used, for example, the entry “executable time” is prepared as an additional information entry in the processing item storage section 120. According to this method, if the current time differs from the executable time set in this entry, the notification determination section 130 unconditionally determines “do not execute notification”. By using additional information in this manner, notification of information about a processing item can be performed at a more suitable timing.

In the first embodiment, the processing in step S11 may be performed for each unexecuted processing item in the processing item storage section. This makes it possible for the notification determination section 130 to determine execution/nonexecution of notification by using more accurate position and time when, for example, it requires much time to notification determination processing associated with each processing item or the user is moving at high speed.

In each embodiment described above, no special processing is performed for any processing item whose expiration date has elapsed. However, the notification determination section 130 may unconditionally determine “execute notification” with respect to a processing item whose expiration date has elapsed. In contrast to this, the notification determination section 130 may unconditionally determine “do not execute notification” with respect to a processing item whose expiration date has elapsed.

What is claimed is:

1. A notification system for notifying a user of a processing item at a specific timing in accordance with an information input about the processing item including an execution position and expiration date of execution, wherein whether to notify the user of the processing item is determined on the basis of a distance between a current position of the user and the execution position included in the processing item, and a time difference between current time and the expiration date of execution included in the processing item.

2. A notification system for notifying a user of a processing item at a specific timing in accordance with an information input about the processing item including an execution position and expiration date of execution, comprising:
processing item input means having a function of inputting information about a processing item;
processing item storage means having a function of storing the processing item input by said processing item input means;
position measuring means having a function of measuring a current position of a user;
timepiece means having a function of measuring current time;
notification determination means having a function of determining whether to notify the user of the processing item, on the basis of a time difference between the current time and the expiration date of execution included in the processing item stored in said processing item storage means and a distance between the current position and the execution position included in the processing item; and
notification means having a function of notifying the user.

3. A system according to claim 1, wherein when it is determined whether to notify the user of a processing item whose expiration date of execution is not designated, a distance between the current position and an execution position included in the processing item is used.

4. A system according to claim 2, wherein when it is determined whether to notify the user of a processing item whose expiration date of execution is not designated, a distance between the current position and an execution position included in the processing item is used.

5. A notification server for notifying a user of a processing item including a stored expiration date of execution and a stored execution position at a specific timing, comprising:
processing item storage means having a function of storing information about the processing item; and
notification determination means having a function of determining whether to notify the user of the processing item, on the basis of a time difference between current time and the expiration date included in the processing item stored in said processing item storage means and a distance between a current position and the execution position included in the processing item.

6. A server according to claim 5, wherein when it is determined whether to notify the user of a processing item whose expiration date of execution is not designated, a distance between the current position and an execution position included in the processing item is used.

7. A notification method of notifying a user of a processing item including an expiration date and an execution position at a specific timing, comprising:
the processing step of acquiring each information about current time and a current position of the user;
the processing step of calculating a distance between the execution position included in the processing item and the current position of the user;
the processing step of calculating a time difference the current time and an expiration date of execution included in the processing item;
the processing step of calculating a degree of necessity of notification on the basis of the distance and the time difference; and
the processing step of determining whether to notify the user of the processing item, in accordance with a value of the degree of necessity of notification.

8. A notification method of notifying a user of a processing item at a specific timing in accordance with an information input about the processing item including an expiration date of execution and an execution position, comprising:
the processing step of causing the user to input information about the processing item including the expiration date of execution and the execution position;
the processing step of acquiring each information about current time and a current position of the user;
the processing step of calculating a distance between the execution position included in the processing item and the current position of the user;
the processing step of calculating a time difference between the current time and the expiration date of execution included in the processing item;
the processing step of calculating a degree of necessity of notification on the basis of the distance and the time difference; and
the processing step of notifying the user of the processing item when the degree of necessity of notification exceeds a predetermined notification threshold.

9. A method according to claim 7, wherein when it is determined whether to notify the user of a processing item whose expiration date of execution is not designated, a distance between the current position and an execution position included in the processing item is used.

10. A method according to claim 8, wherein when it is determined whether to notify the user of a processing item whose expiration date of execution is not designated, a distance between the current position and an execution position included in the processing item is used.

11. A recording medium recording a program for executing a notification method of notifying a user of a processing item including an expiration date and an execution position at a specific timing, the program comprising:
processing of acquiring each information about current time and a current position of the user;
processing of calculating a distance between the execution position included in processing item and the current time of the user;
processing of calculating the time difference between a time difference the current time and an expiration date of execution included in processing item;
processing of calculating a degree of necessity of notification on the basis of the distance and the time difference; and
processing of determining whether to notify the user of processing item, in accordance with a value of the degree of necessity of notification.

12. A recording medium recording a program for executing a notification method of notifying a user of a processing item at a specific timing in accordance with an information input about the processing item including an expiration date of execution and an execution position, the program comprising:
the processing step of causing the user to input information about the processing item including the expiration date of execution an the execution position;
processing of acquiring each information about current time and a current position of the user;
processing of calculating a distance between the execution position included in the processing item and the current position of the user;
processing of calculating a time difference between the current time and the expiration date of execution included in the processing item;
processing of calculating a degree of necessity of notification on the basis of the distance and the time difference; and
the processing step of notifying the user of the processing item when the degree of necessity of notification exceeds a predetermined notification threshold.

13. A medium according to claim 11, wherein when it is determined whether to notify the user of a processing item whose expiration date of execution is not designated, a distance between the current position and an execution position included in the processing item is used.

14. A medium according to claim 12, wherein when it is determined whether to notify the user of a processing item whose expiration date of execution is not designated, a distance between the current position and an execution position included in the processing item is used.
